(19) United States
(12) Patent Application Publication
(10) Pub. No.: US 2025/0318676 A1
(43) Pub. Date: Oct. 16, 2025

(54) Manual Juicer

(71) Applicant: Hayrullah Özdemir, Düsseldorf (DE)

(72) Inventor: Hayrullah Özdemir, Düsseldorf (DE)

(21) Appl. No.: 18/862,582

(22) PCT Filed: Apr. 28, 2023
(86) PCT No.: PCT/DE2023/200085

§ 371 Date: Nov. 4, 2024

(30) Foreign Application Priority Data
May 5, 2022 (DE) 10 2022 111 149.0

(51) Int. Cl. A47J 19/02

(52) U.S. Cl. CPC A47J 19/023

(57) ABSTRACT

A manual juicer, in particular for fruits, such as nuts, tropical fruits, citrus fruits or pomegranates, includes a stand with a support foot, an upper press head which can be moved vertically manually via a lever arm and a lower receiving housing with a press insert. The manual juicer may include a pulp remover which can remove the fruit residues from the receiving housing, whereby the pulp remover includes an annular segment with at least one inwardly aligned bar, preferably several bars, so that the residues can be lifted evenly. Alternatively, a pulp remover includes a strainer and a handle.

The invention relates to a manual juicer, in particular for fruits such as nuts, tropical fruits, citrus fruits or pomegranates, consisting of a stand with a base, an upper pressing head which can be moved vertically manually via a lever arm and a lower receiving housing with a pressing insert.

Manual juicers consist of a stand with a base, whereby the base is dimensioned so that the juicer has a secure footing. The height of an upper press head can be adjusted manually using a lever arm, whereby the lever arm is designed in such a way that sufficient pressing pressure is achieved. The press head is pressed into a housing with a press insert after, for example, tropical fruit, nuts, citrus fruit or a pomegranate has been inserted. With the help of the upper press head, the fruit is pressed against the press insert of the receiving housing so that the fruit juice can flow out. The lower part of the housing usually has an outlet so that the fruit juice can run out via the outlet, for example into a container or glass. Juicers of this type are used in the home, but also in offices to provide family members or staff with freshly squeezed juice.

As this is a manual juicer, the residue must be removed from the receiving housing after the fruit has been squeezed. Depending on the pressing pressure generated, the fruit residues may be crushed to such an extent that they are no longer in a single piece form, which means that a lot of manual work is required to remove the residues from the receiving tray.

The present invention is therefore based on the task of improving the disposal of fruit residues in order to remove them more easily from the receiving housing.

To solve the problem, it is provided that the receiving housing is intended to accommodate a press arrangement consisting of a press insert and a manually operable pulp remover. Further advantageous embodiments of the invention are shown in the sub-claims.

The press arrangement used consists of a press insert and the manually operated pulp remover. With the help of a pulp remover for the fruit residues, the disposal of the residues is considerably simplified. The operator of the juicer does not have to remove the residues by hand or laboriously remove the residues from the receiving housing. Instead, it is now possible to use the pulp remover to lift the residues from the press insert so that they can be quickly disposed of in a waste garbage can provided for organic waste. In this case, it is provided that the pulp remover is placed together with the press insert in the receiving housing and the press insert remains in the receiving housing, only the pulp remover is lifted to such an extent that the pulp remover can be removed together with the residues from the receiving housing. Furthermore, it is easily possible to clean the receiving housing, the press insert and the pulp remover under running water if necessary and then reuse them. As a rule, such thorough cleaning is only necessary after a large number of pressing processes.

In an embodiment of the invention, it is provided that the pulp remover consists of an annular segment with at least one inwardly oriented bar and a handle, the annular segment preferably being designed as a circular ring. The annular segment has an inner diameter that is slightly larger than the diameter of the press insert so that the segment can be guided over the press insert. With the help of the inwardly aligned bar, preferably several bars, the fruit residues are also lifted when the pulp remover is lifted so that they can be disposed of properly. For this purpose, the press insert has corresponding recesses in which the bar or bars are inserted.

Preferably, the pulp remover can be equipped with two, four, six or eight bars, which are arranged in the plane of the annular segment. Several bars facilitate the lifting of the residues, whereby these are preferably arranged opposite each other in pairs and have a width of approx. 4 mm to 10 mm in order to form a sufficient contact surface so that the residues can be completely lifted and thus removed via the press insert. If the bars are arranged opposite each other in pairs, for example with a total of 4 bars, the pressed-out parts of the fruit are lifted evenly and thus prevented from falling down. The higher the number of bars, the more secure the hold of the residue on the pulp remover.

Alternatively, it is possible for the pulp remover to consist of a strainer insert with a handle. The strainer insert is preferably used for smaller fruits such as grapes or the like, which can also be squeezed using the manual juicer. To make it easier to remove the skins from smaller fruits, a strainer insert is used in this case, on which the peels are placed and can be disposed of very easily after being lifted out of the housing.

To operate the pulp remover, it is provided with a handle that protrudes radially outwards and angled at least twice over the upper edge of the receiving housing. This allows the operator of the juicer to grasp the pulp remover without difficulty and remove it upwards from the receiving housing together with the residues. Alternatively, it is possible for the pulp remover to be equipped with a thickened edge instead of a handle, which also allows the pulp remover to be gripped and lifted together with the residues in order to dispose of the residues.

In an embodiment of the invention, it is provided that the handle is integrally connected to the annular segment and that the annular segment, the bars and the handle are made of a flat material. The material itself can be made of stainless steel, for example, but can also be made of a plastic material, whereby the flat design provides a large contact surface on the underside of the residues and thus not only lifts all residues, but can also rest securely on the pulp remover. The strainer insert can also be manufactured in a similar form, also with a handle that is integrally connected to the strainer insert, whereby the strainer insert and the handle can be made of stainless steel or a plastic material. In this embodiment, the strainer insert can also consist of a flat disk with apertures, to which the handle is integrally formed.

In a further embodiment of the invention, it is provided that the press insert is provided with recesses corresponding to the bars, so that the bars can lie in the recesses. Preferably, the press insert, was well as the pulp remover, is provided with two, four, six or eight recesses in order to receive the bars of the pulp remover. For this purpose, it is intended that the bars and recesses each have an identical angular distance to one another so that the pulp remover can be inserted at different angles to the juicer depending on the number of bars present. It is also possible for the number of recesses in the press insert to be greater than the number of bars, so that the pulp remover can be inserted into the press insert in different rotational positions.

In a further embodiment of the invention, it is provided that the diameter of the annular segment is larger than the diameter of the press insert. This ensures that the pulp remover can be placed on the press insert without major problems, regardless of the number of bars or recesses in the press insert. The press insert also consists of a hemisphere with a circumferential edge that rests in the housing. Different press inserts can be exchanged and corresponding pulp removers can be provided.

In a further embodiment of the invention, it is provided that the edge of the press insert has a wave-shaped structure on the upper side in such a way that the lowest point is arranged in the area of the recesses in each case. This measure ensures that the squeezed juice can flow off laterally from the edge, namely to the existing recesses, whereby the recesses are led through the press insert to the underside of the press insert, so that the squeezed juice can flow downwards into a funnel or the like. To make it easier to insert the pulp remover, the recess of the press insert is designed to be wider than the width of the bars of the pulp remover, so that there is sufficient clearance to place the pulp remover on the press insert without much effort. In order to insert the press insert into a lower collecting tray without any problems, it is intended that the recesses in the lower circumferential edge of the press insert are opened in a V-shape. If it is a strainer insert, this is also located inside the receiving housing and can be lifted using the handle to remove the residue.

The juicer is also equipped with an upper press head, which has the shape of a hemisphere, for example, and is intended for attachment to a vertically arranged pressure block. The pressure block is part of the manual juicer and can be adjusted vertically by a lever arm, so that a corresponding contact pressure is applied to the pressure block via the lever arm, which in turn is intended for contact with the tropical fruits or pomegranates.

The upper press head is preferably bell-shaped and screwed to the pressure block, for example. Alternatively, it is possible for the upper press head to have an inner shell, which is held in the press head in a clamping manner, for example. In this case, the inner shell can be easily removed from the upper press head so that the inner shell can also be cleaned.

In a particular embodiment of the invention, it is provided that the press head is equipped with a radial recess below the screw connection on the inside or the inner shell. This radial recess serves to accommodate the stalk ends, for example of a pomegranate, so that the pressing pressure is not exerted on the stalk but on the lateral peels of the pomegranate in order to optimally squeeze out the juice. The stalk therefore rests in the recess and is not crushed during the pressing process.

In a further embodiment of the invention, it is provided that the upper press head consists of a hollow cylinder with a base. In this case, the base is oriented upwards so that the fruit resting on the strainer insert can be crushed. In this case, the hollow cylinder can have a low overall height; it is important that the base comes into contact with the fruit and that it can be squeezed out between the base and the sieve. Alternatively, a punch can be used for squeezing.

It is also possible for the upper press head to be provided with a splash guard, which covers the press head, for example in the form of an arch, so that fruit juice splashing upwards is collected and drips off the splash guard into the lower housing.

In a further embodiment of the invention, it is provided that a lower press shell for the press insert is provided with vertically extending inwardly projecting beads which correspond to the slots. The beads prevent the press insert from twisting on its own, whereby the squeezed juice can still flow downwards through the slots and the receiving press tray has a hole through which the juice can flow out. The base of the press bowl is conical or stepped for this purpose. The press tray itself is pot-shaped with a circumferential rim in which the beads are pressed inwards, with the beads extending over at least part of the height of the circumferential rim in the vertical direction of the press tray.

The present invention is characterized by the fact that a manual juicer is equipped with a pulp remover that facilitates the removal of residues from, for example, tropical fruits or pomegranates. The pulp remover is used to lift the residue out of the receiving housing and dispose of it properly. Once the residue has been removed, the pulp remover can be reinserted into the receiving housing. To lift the residues, the pulp remover is advantageously equipped with at least one, preferably several, bars that grip the residues and lift them upwards. Both the press insert and the pulp remover are equipped with a certain number of corresponding bars or recesses so that the bars can come to rest in the existing recesses. The pulp remover is generously dimensioned so that it can be placed on the press insert without jamming and the bars can be positioned in the recesses. The recesses also serve as a drainage aid for the squeezed juice, which can be collected in a lower funnel and fed to another container or a glass if necessary.

In an alternative embodiment, a strainer insert is used instead of a press insert, on which smaller fruits can be stored and pressed out with the aid of a hollow cylindrical press head or punch. In this case too, the residues of the fruit can be removed from the receiving housing with the aid of a pulp remover.

The invention is explained in more detail below with reference to the figures.

It shows

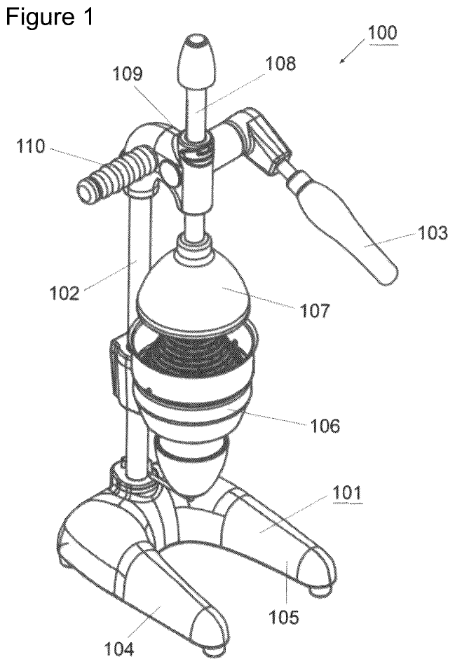

FIG. 1 in a perspective view of a manual juicer,

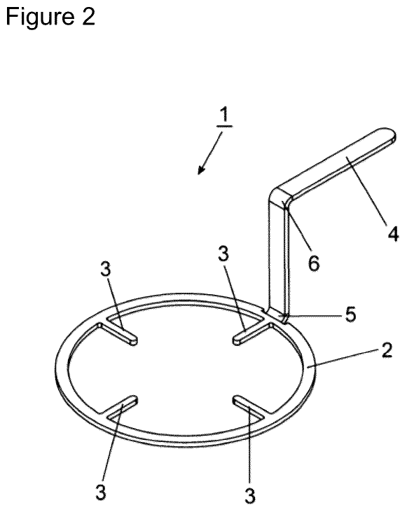

FIG. 2 in a perspective view of an exemplary pulp remover,

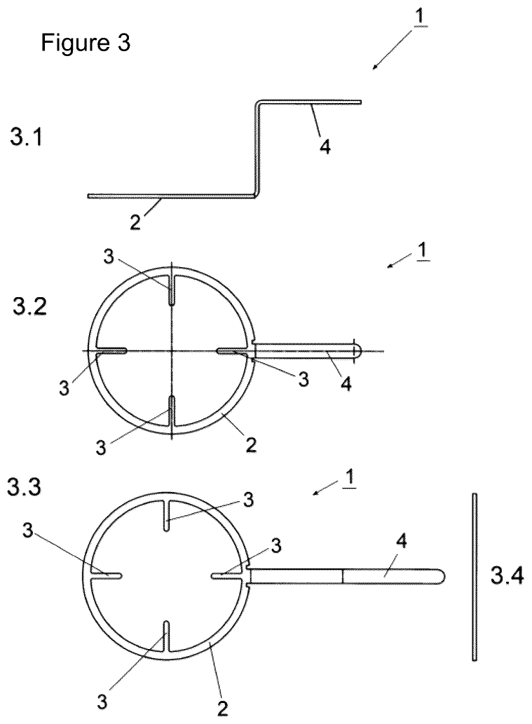

FIG. 3 in a perspective top and bottom view of a press insert,

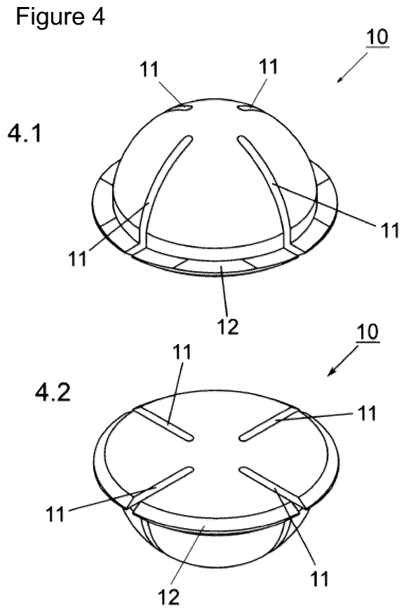

FIG. 4 in three views of the press insert from FIG. 2,

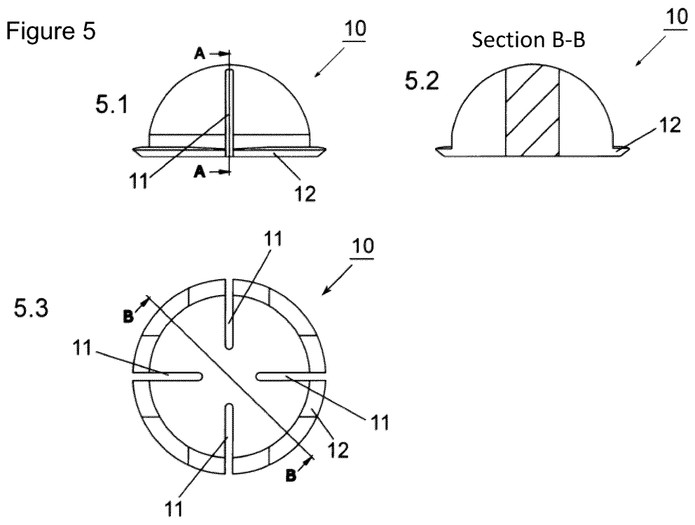

FIG. 5 in two perspective views of a press head as used for the juicer,

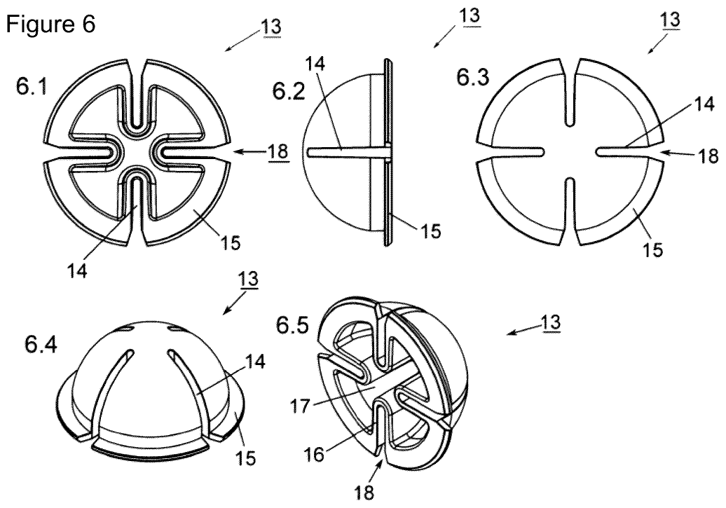

FIG. 6 in two perspective views and several side views of a further embodiment of a press insert,

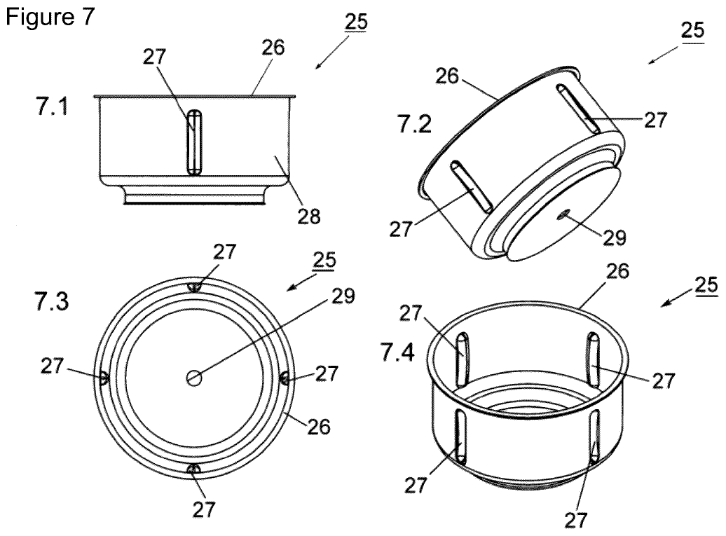

FIG. 7 in two perspective and two side views of a press shell with beads,

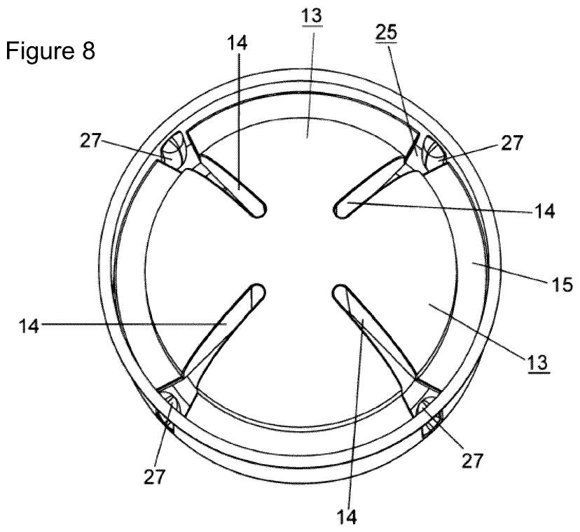

FIG. 8 in a perspective top view of the press shell with inserted press head,

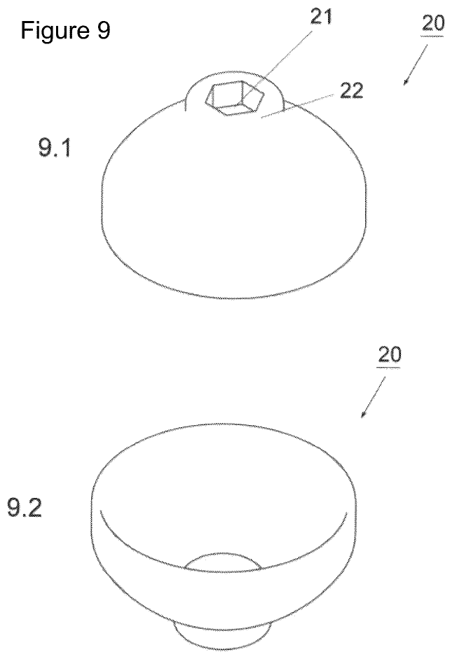

FIG. 9 in two perspective views of the press head shown in FIG. 5,

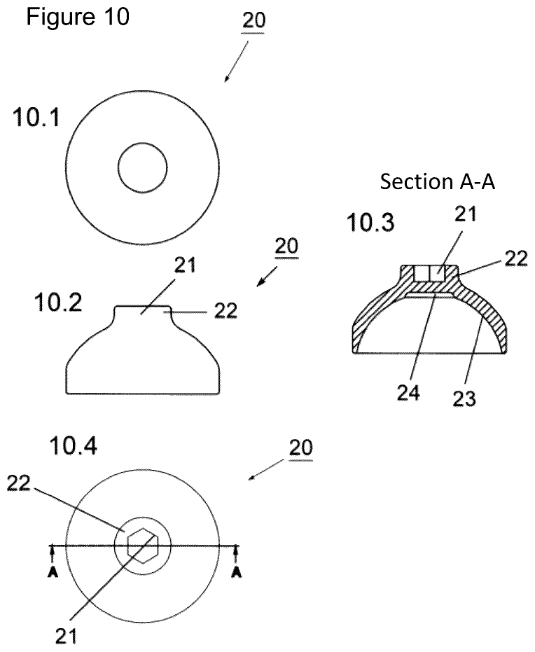

FIG. 10 in a total of four views of the press head shown in FIG. 5,

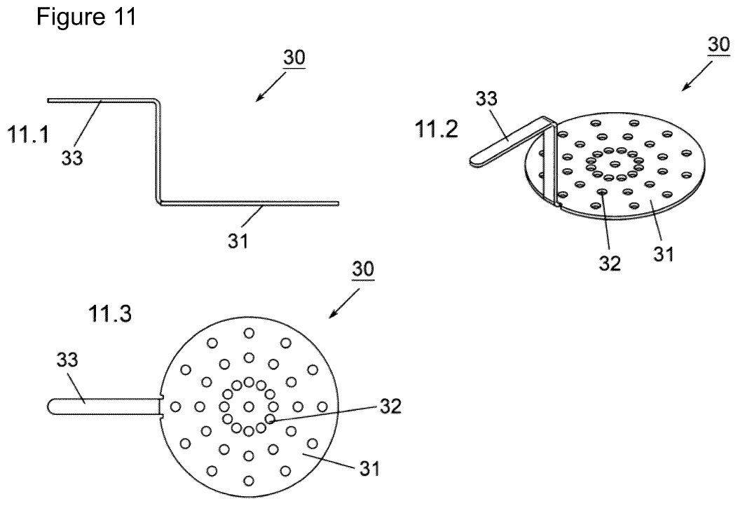

FIG. 11 in a perspective and two side views of a pulp remover for a strainer insert,

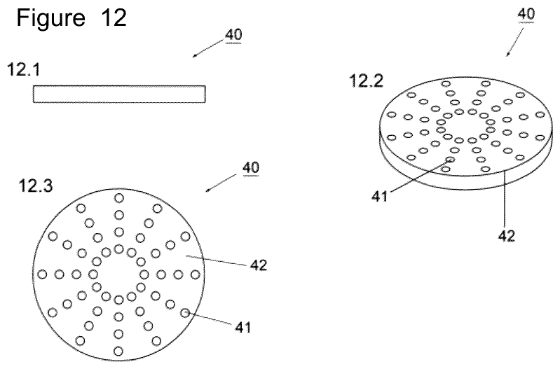

FIG. 12 in three views of a strainer insert as used in connection with the pulp remover shown in FIG. 8,

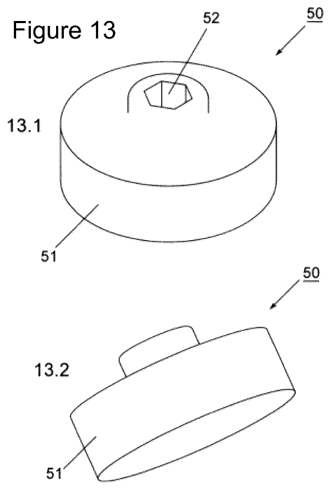

FIG. 13 in two perspective views of a press head for the strainer insert according to FIG. 8,

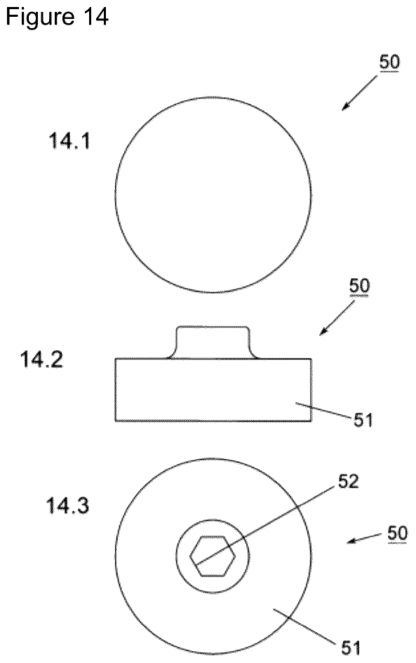

FIG. 14 in three further views of the press head shown in FIG. 10,

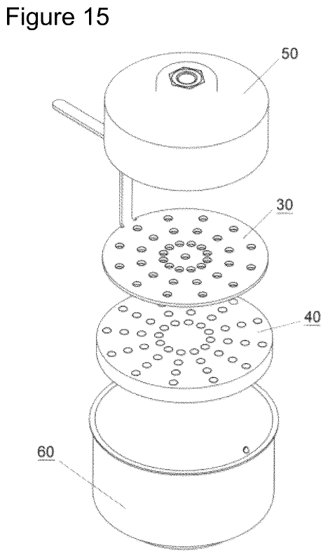

FIG. 15 Perspective exploration view of the housing with press insert, pulp remover and press head,

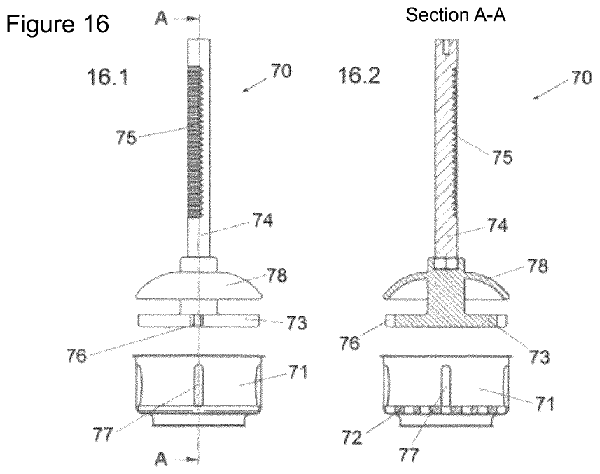

FIG. 16 side view and sectional view of an alternative press head with splash guard and

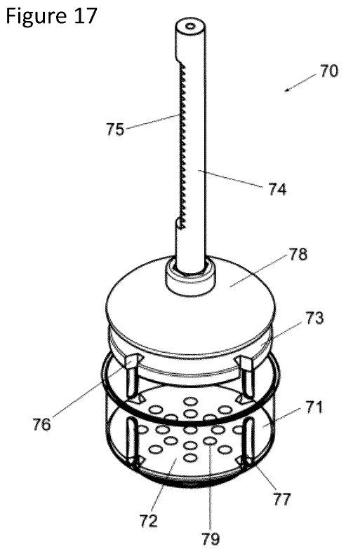

FIG. 17 is a perspective view of the press head with splash guard.

FIG. 1 shows a perspective view of a manual juicer 100, which consists of a base 101, a stand 102 and a pivotable lever arm 103. The base 101 is approximately U-shaped and has two legs 104, 105, which provide stability, whereby a glass or other container can be placed between the two legs 104 and 105, for example. A receiving housing 106 is located directly above the base 101, which can be used to hold different press inserts. A press head 107 is connected to the lever arm 103 via a pressure rod 108, so that the press head 107 can be moved vertically when the lever arm 103 is pressed down. The pressure rod 108 is accommodated in a joint 109 of the stand 102. The stand 102 itself has a handle 110 to have a stabilizing effect on the juicer if necessary.

The other figures refer to the possible inserts of the receiving housing 106 and the press head 107.

FIG. 2 shows a perspective view of a pulp remover 1, which has an annular segment 2 consisting of a full circle with bars 3 aligned to the center and a handle 4. Both the annular segment 2 and the bars 3 and the handle 4 are made of a flat material, preferably stainless steel, but can also be a plastic material. The bars are each offset by 90 degrees and point towards the center of the segment 2. The handle 4 is integrally formed on the segment 2 and has a first bend 5 and a second bend 6, so that the end of the handle 4 is offset parallel to the plane of the segment 2. The bends 5 and 6 are designed so that the handle 4 protrudes from the housing so that the pulp remover 1 can be lifted.

FIGS. 3.1 to 3.4 show the pulp remover 1 in a top and side view as well as in an angled view. The top view reveals the embodiment as already known from FIG. 1, namely with an annular segment 2, the bars 3 and a handle 4. The side view, on the other hand, reveals the height offset between the annular segment 2 and the handle 4. The further illustration of the bending also shows the pulp remover 1, from which it can be seen that the pulp remover 1 is punched out in one piece from the desired material and the handle 4 is brought into the desired position by bending it twice.

FIGS. 4.1 and 4.2 show two perspective views of a press insert 10, namely the top and bottom of the press insert 10. The press insert 10 is inserted into the receiving housing and has circumferentially distributed recesses 11, which have a corresponding angular spacing to the bars 3 of the pulp remover 1. The press insert consists of a hemisphere in which, on the one hand, the recesses are incorporated and, on the other hand, a circumferential edge 12 is formed, which has an undulating structure that slopes down towards the recesses so that the pressed-out liquid can run off. The perspective bottom view of the press head shows that the recesses 11 extend into the underside of the press head 10 so that the squeezed liquid can drip off downwards. The flat underside of the press insert 10 comes to rest in the receiving housing, which also has a drain at the bottom so that the squeezed juice can run off into a container or possibly into a glass placed underneath.

FIGS. 5.1 to 5.3 show three views, namely a side view, a top view and a sectional view of the press insert 10 as known from FIG. 3. The first side view shows the hemispherical shape of the press insert 10, as well as the circumferential edge 12, which has an undulating structure to the respective recesses 11. The top view shows the four recesses 11, which correspond to the bars 3 of the pulp remover 1. The sectional view along the sectional line A-A shows a section along two opposing recesses 11, so that only the central core area of the press insert 10 is shown cut.

FIGS. 6.1 to 6.5 show two perspective views and three further views of a press insert 13 which, in contrast to the version shown in FIG. 5, has slots 14 which open in a V-shape in the lower circumferential edge 15. On the one hand, the slots 14 are intended for draining the fruit juice and, on the other hand, the V-shaped opening facilitates insertion into a press tray, as shown in FIG. 7. The press insert 13 has, for example, four slots 14, each offset by 90 degrees, and is hollow-walled, so that the lower central area 17 of the press insert 13 is hollow. In this case, the slots 14 are each bounded by a U-shaped bar 16. The V-shaped opening 18 of the slots 14 is clearly visible in the present views.

FIGS. 7.1 to 7.4 show a press shell 25 which tapers downwards in steps. The press shell 25 is pot-shaped and has a beveled circumferential edge 26 in the upper area and beads 27 on the inside. The beads 27 extend almost over the entire height of the circumferential edge 28 in vertical alignment. The base also has a bore 29 through which the fruit juice can flow out.

FIG. 8 shows a perspective top view of the press shell 25 with the press insert 13 inserted. The beads 27 prevent the press insert 13 from twisting inside the press shell 25, with the V-shaped expansions 18 each accommodating the beads 27.

FIGS. 9.1 to 9.2 show two perspective views, namely a top and bottom view, of the upper press head 20, which is connected to a pressure rod of the juicer. For this purpose, the press head 20 has a hexagonal recess 21 in an upper cylindrical section 22. The press head 20 is otherwise also hollow-spherical in shape as a hemisphere, the inside of which is intended for contact with the tropical fruit or pomegranate and can squeeze juice out of the tropical fruit or pomegranate as a result of the pressure exerted by a lever arm. Alternatively, it is possible that the press head 20 is additionally equipped with an inner shell, which is held clamped inside the press head 20 and can be removed for cleaning.

FIGS. 10.1 to 10.4 show a total of four views of the press head 20 as known from FIG. 5. A side view shows the basic bell-shaped form of the press head 20, the inner surface 23 of which comes into contact with the tropical fruits or pomegranates. A cylindrical attachment 22 with a hexagonal recess 21 is used for connection to a pressure block of the juicer. The inner surface 23 has a radial recess 24 in which, for example, the stalk of a pomegranate can be placed so that the stalk is not pressed, but only the outer peel of the pomegranate. If tropical fruits are to be squeezed, this radial recess 24 is not important. A first plan view shows the underside of the press head 20 and a second plan view shows the upper side of the press head 20 with the hexagonal recess 21 and the cylindrical section 22. The sectional drawing according to sectional line A-A also shows the wall structure of the press head 20 again, with the cylindrical section 22 and the hexagonal recess 21 as well as the inner surface 23 with radial recess 24.

FIGS. 11.1 to 11.3 show a perspective view and two side views of a pulp remover 30 as used together with a strainer insert as shown in FIG. 11. The pulp remover 30 consists of a disk 31, which is provided with a plurality of apertures 32. The apertures 32 serve to drain off the fruit juice, while the fruit residue remains on the disk 31. A handle 33 is integrally formed on the disk 31. The handle 33 consists of two sections which are angled twice in relation to the disk 31.

From the side view and top view, the shape of the pulp remover 30 can be seen again, with the disk 31 and the openings 32 as well as the handle 33.

FIGS. 12.1 to 12.3 show a perspective view and two side views of a press insert 40 with apertures 41, which are provided for draining the fruit juice. The press insert 40 in the form of a flat disk 42 is inserted into the receiving housing and then the pulp remover 30 is placed on it before the fruit is inserted into the receiving housing. The press insert 40 and pulp remover 30 are preferably used for smaller shell fruits such as grapes or strawberries.

FIGS. 13.1 and 13.2 show two perspective views of a press head 50 as used with the pulp remover 30 and the press insert 40. The upper press head 50 consists of a cylindrical press head 50, which can be connected to the press rod via a receiving opening 52. The press head 50 can consist of a flat disk or alternatively of a short hollow cylinder with a base.

FIGS. 14.1 to 14.3 show three views of the press head 50 as already shown in FIG. 13, with a cylindrical pressure plunger 51 and a receiving opening 52 for connection to the pressure rod.

FIG. 15 shows a perspective view of the design of the press insert as it is used for smaller fruits, for example. The receiving housing 60 is used to insert a press insert 40 and a pulp remover 30 onto which the fruit to be pressed is then placed. Above the pulp remover 30 is a press head 50, which can be moved vertically with the help of the lever arm and thus the inserted fruit is pressed out. The entire arrangement is integrated into the manual juicer and can be used as required.

FIG. 16 shows a side view and a sectional view along section line A-A of a pressing device 70, consisting of a receiving housing 71, a press insert 72 inserted therein and an insertable pulp remover, which is not shown in the drawings, and a press head 73, which can be moved vertically with the aid of a lever arm, the lever arm being operatively connected to a pressure rod 74 via a toothing 75. In this case, the press head 73 consists of a flat disk which has circumferentially distributed recesses 76 that correspond to the beads 77 of the press pot 71, so that the press head 73 lies in the receiving housing 71 in such a way that it cannot rotate. To prevent the fruit juice from splashing upwards, a splash guard 78 is provided, which curves over the press insert 73 in the shape of a bell.

The sectional view according to section A-A shows, on the one hand, the applied press insert 72 and, on the other hand, the recess 76, which is arranged to correspond to the beads 77.

FIG. 17 shows a perspective view of the pressing device 70, as known from FIG. 16. In this case, the receiving housing 71 is shown semi-transparent, so that the press insert 72 with bores 79 for draining the fruit juice is visible. The beads 77 also form an anti-twist protection and correspond to the recesses 76 of the press head 73, which is covered by a splash guard 78.

### LIST OF REFERENCE SYMBOLS

1 Pulp remover
2 Annular segment
3 Bar
4 Handle
5 Bend
6 Bend
10 Press insert
11 Recesses
12 Circumferential edge
13 Press insert
14 Slot
15 Edge
16 Bar
17 Area
18 Opening
20 Press head
21 Hexagonal recess
22 Cylindrical section
23 Inner surface
24 radial recess
25 Press shell
26 Edge
27 Beads
28 Edge
29 Bore

30 Pulp remover
31 Disk
31 Disk
32 Apertures
33 Handle
33 Handle
40 Press insert
41 Apertures
42 Disk
50 Press head
50 Press head
51 Pressure plunger
52 Receiving opening
52 Receiving opening
60 Receiving housing
70 Pressing device
71 Receiving housing
72 Press insert
73 Press head
74 Pressure rod
75 Toothing
76 Recess
77 Bead
78 Splash protection
79 Borehole
100 Juicer
101 Base
102 Stand
103 Lever arm
104 Leg
105 Leg
106 Housing
107 Press head
108 Pressure rod
109 Joint
110 Handle

1. Manual juicer (100), comprising:
a stand (102) with a base (101),
an upper press head (20, 50, 73), which is manually vertically movable via a lever arm (103), and
a lower receiving housing (60, 71, 106) with a press insert (10, 13, 40, 72),
wherein the receiving housing (60, 71, 106) accommodates a press arrangement which comprises a press insert (10, 13, 40, 72) and a manually operable pulp remover (1, 30).

2. Manual juicer according to claim 1, wherein the pulp remover comprises of an annular segment (2) with at least one inwardly oriented bar and a handle, or that the pulp remover comprises a strainer insert with a handle.

3. Manual juicer according to claim 2, wherein the annular segment forms a circular ring, and/or in that the pulp remover has two, four, six or eight bars, which are arranged in the plane of the annular segment.

4. Manual juicer according to claim 2, wherein the bars are arranged opposite each other in pairs, and/or in that the bars have a width of 4 mm-10 mm.

5. Manual juicer according to claim 2, wherein the handle is integrally connected to the annular segment, and/or in that the annular segment, the bars and the handle comprise a bent flat material.

6. Manual juicer (100) according to claim 2, wherein the strainer insert comprises a flat disk with openings and handle.

7. Manual juicer according to claim 2, wherein the pulp remover has a handle which projects radially outwards at an angle at least twice beyond the upper edge of the receiving housing.

8. Manual juicer (100) according to claim 2, wherein the press insert is provided with recesses corresponding to the bars, so that the bars lie in the recesses, and/or in that the press insert has two, four, six or eight recesses.

9. Manual juicer according to claim 2, wherein the bars and recesses each have an identical angular spacing, and/or in that the number of recesses of the press insert is greater than the number of bars.

10. Manual juicer according to claim 2, wherein the diameter of the annular segment is larger than the diameter of the press insert, and/or that the recesses of the press insert are wider than the width of the bars of the pulp remover.

11. Manual juicer according to claim 1, wherein the press insert comprises a hemisphere with a circumferential edge, and/or that the circumferential edge of the press insert has an undulating structure on the upper side in such a way that the lowest point is arranged in the region of the recess in each case.

12. Manual juicer according to claim 1, wherein the recesses are led through the press insert to the underside of the press insert, and/or in that the recesses are opened in a V-shape in the lower circumferential edge.

13. Manual juicer according to claim 1, wherein that the press insert comprises a flat disk with apertures.

14. Manual juicer according to claim 1, wherein the upper press head has the shape of a hemisphere and is provided for attachment to a vertically arranged pressure block, and/or in that the upper press head is screwed to the pressure block in the shape of a bell.

15. Manual juicer according to claim 1, wherein the upper press head comprises an inner shell which is held in a clamping manner in the upper press head, and/or that the upper press head below the screw connection on the inner surface of the upper press head or the inner shell is equipped with a radial recess.

16. Manual juicer according to claim 1, wherein the upper press head comprises a hollow cylinder with a base or a press plunger, and/or in that the upper press head is provided with a splash guard.

17. Manual juicer (100) according to claim 1, wherein a lower press shell (25) or a receiving housing for the press insert is provided with vertically extending inwardly projecting beads, which correspond to the recesses, and/or in that the press shell or the receiving housing is pot-shaped and the beads extend at least partially in the vertical direction at the height of a circumferential edge of the press shell or the receiving housing.

18. A manual juicer, comprising:
a stand with a base;
a press head being manually and vertically movable by a lever arm; and
a receiving housing below the press head and holding a press arrangement,
wherein the press arrangement comprises a press insert and a manually-operable pulp remover.
